(19) United States
(12) Patent Application Publication
(10) Pub. No.: US 2014/0370066 A1
(43) Pub. Date: Dec. 18, 2014

(54) Antimicrobial Glass-Ceramics

(71) Applicant: CORNING INCORPORATED, Corning, NY (US)

(72) Inventors: George Halsey Beall, Big Flats, NY (US); Nicholas Francis Borrelli, Elmira, NY (US); Robert Michael Morena, Lindley, NY (US); Charlene Marie Smith, Corning, NY (US); Ying Wei, Painted Post, NY (US)

(21) Appl. No.: 14/471,439

(22) Filed: Aug. 28, 2014

Related U.S. Application Data
(63) Continuation of application No. 13/649,499, filed on Oct. 11, 2012.
(60) Provisional application No. 61/546,302, filed on Oct. 12, 2011.

(51) Int. Cl. A01N 25/08; A01N 59/20

(52) U.S. Cl. CPC A01N 25/08; A01N 59/20
USPC 424/409; 424/630

(57) ABSTRACT

The application discloses the formation of antimicrobial glass-ceramic articles having an amorphous phase and a crystalline phase and an antimicrobial agent selected from the group consisting of silver, copper and a mixture of silver and copper. The antimicrobial glass-ceramic can have a Log Reduction of >2.

This application is a continuation application of U.S. application Ser. No. 13/649,499, filed Oct. 11, 2012, which claims the benefit of priority under 35 U.S.C. §119 of U.S. Provisional Application Ser. No. 61/546302 filed Oct. 12, 2011 the contents of which are relied upon and incorporated herein by reference in their entirety.

### FIELD

This disclosure is directed to antimicrobial glass-ceramics, and in particular antimicrobial glass-ceramics containing silver, copper or a combination of silver and copper.

### BACKGROUND

There is a need for antimicrobial structures which have improved strength.

### SUMMARY

In one aspect the present disclosure is directed to the formation of an antimicrobial glass-ceramic (“GC”) having an amorphous phase and a crystalline phase and an antimicrobial agent selected from the group consisting of silver, copper and a mixture of silver and copper.

Another aspect of the disclosure is a method of making a antimicrobial article having at least one selected antimicrobial agent therein, the method comprising the steps of providing a glass-ceramic substrate without an antimicrobial agent thereon, the glass-ceramic substrate having a crystalline component and an amorphous component; and subjecting said glass-ceramic substrate to an ion-exchange process using an ion-exchange bath containing at least one ion-exchangeable antimicrobial agent salt and an exchangeable alkali metal salt to thereby form a antimicrobial glass-ceramic article, wherein the antimicrobial agent(s) is selected from the group consisting of copper, silver and a mixture of copper and silver.

The silver and copper, or mixture thereof, can be zero valent existing in the GC as Ag⁰ or Cu⁰, which is the metallic form; can be ionic and exist in the GC as Ag⁺¹, Cu⁺¹ or Cu⁺²; or can be in the GC as a mixture of the zero valent and ionic forms of one or both agents, for example, Ag⁰ and Cu⁺¹ and/or Cu⁺², Ag⁺¹ and Cu⁰, and other combination of the zero valent and ionic species. The antimicrobial agent can be incorporated into the GC by either (1) ion-exchange of a preformed GC using an ion-exchange bath containing one or both of the foregoing antimicrobial agents, or (2) by including one or both of the foregoing antimicrobial agents into batched materials used to prepare a glass that is then cerammed to form a GC. In (1), the antimicrobial agent will be present in the GC in ionic form, as the oxide, since nitrates of the antimicrobial agent can be used for the ion-exchange and because the nitrate species on the GC are easily decomposed during the ion-exchange process. While chlorides can also be used, their use can give rise to problems, for example, degradation of the GC and subsequent loss of its desirable properties. In (2) the antimicrobial agent is also deemed present as the oxide due to the conditions of melting, forming, nucleating and ceramming the glass, all of which can be carried out in air. In either case the resulting antimicrobial agent containing GC can be used as-is or can be subjected to a reduction step.

### BRIEF DESCRIPTION OF THE DRAWINGS

FIG. 1 is an electron microprobe (EMP) analysis of a spodumene-type glass-ceramic after ion-exchange using a 5 wt % AgNO₃/95 wt % NaNO₃ bath at 420° C. for 20 minutes.

FIG. 2A is an EMP analysis after ion-exchange using a 5 wt % AgNO₃/95 wt % NaNO₃ bath at 450° C. for 5 hours.

FIG. 2B is an Ag map of the glass-ceramic of FIG. 2A.

FIG. 3 is a photograph of a spodumene GC (a) after ion-exchange at 420° C. for 20 minutes using 5 wt % Ag in a NaNO₃ bath (top, GC is white) and (b) after reduction at 420° C. for 5 hours in H₂ at 1 atmosphere pressure (bottom, GC is grey).

FIG. 4A and 4B are SEM micrographs of the surface (FIG. 4A) and edge (FIG. 4B) of a spodumene GC after ion-exchange using a 5 wt % AgNO₃/95 wt % NaNO₃ bath at 420° C. for 20 minutes.

FIGS. 5A-5C are SEM micrographs of the spodumene GC of FIGS. 4A/4B after reduction at 450° C. for 5 hours in 1 atmosphere H₂.

FIG. 6 is the EMP analysis of a spodumene GC containing 1 mole % CuO as- made after heat treatment at 1100° C.

### DETAILED DESCRIPTION

As used herein the term “antimicrobial,” means an agent(s) or material, or a surface containing the agent(s) or material that will kill or inhibit the growth of microbes from at least two of families consisting of bacteria, viruses and fungi. The term as used herein does not mean it will kill or inhibit the growth of all species microbes within such families, but that it will kill or inhibit the growth or one or more species of microbes from such families. The components of all the glass-ceramic compositions suitable for ion-exchange, or glasses that are suitable for ion-exchange before being cerammed into a glass-ceramic, are given in terms of weight percent (wt %) as the oxide unless indicated otherwise. Methods of analyzing the contents of antimicrobial agents present on the surface of or/or into the depth of the GC, for example, silver, are described in the commonly owned U.S. patent application Ser. No. 13/197,312 filed on Aug. 3, 2011 in the name of Nicholas Francis Borrelli et al, and titled “Coated, Antimicrobial, Chemically Strengthened Glass and Method of Making.” The teachings of U.S. patent application Ser. No. 13/197,312 are incorporated herein by reference.

The term “glass-ceramic” is defined herein as a material that has both an amorphous component and a crystalline component. Glass-ceramics are microcrystalline solids produced by the controlled devitrification of glass. To make glass-ceramics, glasses are batched, melted, fabricated to shape, and then converted by a heat treatment to a partially-crystalline material with a highly uniform microstructure. The basis of controlled crystallization lies in efficient internal nucleation, which allows development of fine, randomly oriented grains minimizing voids, micro-cracks, or other porosity. Because of the nature of the crystalline microstructure, the mechanical properties, including strength, elasticity, fracture toughness, and abrasion resistance, may be higher in GCs than in glass.

An aspect of the disclosure is an antimicrobial article comprising a substrate comprising a glass-ceramic having a crystalline component, an amorphous component, and at least one antimicrobial agent selected from the group consisting of silver, copper and a mixture of silver and copper.

Another aspect of the disclosure is a method of making a antimicrobial article having at least one selected antimicrobial agent therein, the method comprising the steps of providing a glass-ceramic substrate without an antimicrobial agent thereon, the glass-ceramic substrate having a crystalline component and an amorphous component; and subjecting said glass-ceramic substrate to an ion-exchange process using an ion-exchange bath containing at least one ion-exchangeable antimicrobial agent salt and an exchangeable alkali metal salt to thereby form a antimicrobial glass-ceramic article, wherein the antimicrobial agent(s) is selected from the group consisting of copper, silver and a mixture of copper and silver.

In one embodiment the antimicrobial GC article has a crystalline component in the range of 20-98 Vol % and an amorphous component in the range of 2-80 Vol %. The crystalline component can comprise a single crystalline phase of or a plurality of crystalline phases; that is, one or a plurality of crystalline phases. In another embodiment the antimicrobial GC article has a crystalline component in the range of 20-90 Vol % and an amorphous component in the range of 80-10 Vol %. In an additional embodiment the antimicrobial GC article has a crystalline component in the range of 40-90 Vol % and an amorphous component in the range of 60-10 Vol %.

The crystalline component, in some embodiments, is dispersed substantially uniformly within the glass component and exhibits a particle size ranging between 10 nm-20 microns, for example, 10 nm-19 microns, for example, 10 nm-18 microns, for example, 10 nm-17 microns, for example, 10 nm-16 microns, for example, 10 nm-15 microns, for example, 10 nm-14 microns, for example, 10 nm-13 microns, for example, 10 nm-12 microns, for example, 10 nm-11 microns, for example, 10 nm-10 microns, for example, 10 nm-9 microns, for example, 10 nm-8 microns, for example, 10 nm-7 microns, for example, 10 nm-6 microns, for example, 10 nm-5 microns, for example, 10 nm-4 microns, for example, 10 nm-3 microns, for example, 10 nm-2 microns, for example, 10 nm-1 microns, for example, 10 nm-900 nm, for example, 10 nm-850 nm, for example, 10 nm-800 nm, for example, 10 nm-750 nm, for example, 10 nm-700 nm, for example, 10 nm-650 nm, for example, 10 nm-600 nm, for example, 10 nm-550 nm, for example, 10 nm-500 nm, for example, 10 nm-450 nm, for example, 10 nm-400 nm, for example, 10 nm-350 nm, for example, 10 nm-300 nm. In one embodiment the crystalline component has a particle size in the range of 10 nm-1 micron that is dispersed substantially uniformly within the glass component. In another embodiment the crystalline component has a particle size in the range of 10 nm-5 microns that is dispersed substantially uniformly within the glass component. In a further embodiment the crystalline component has a particle size in the range of 10 nm-2 microns that is dispersed substantially uniformly within the glass component.

The crystalline component, in some embodiments, is dispersed substantially uniformly within the glass component and exhibits an average particle size ranging between 10 nm-20 microns, for example, 10 nm-19 microns, for example, 10 nm-18 microns, for example, 10 nm-17 microns, for example, 10 nm-16 microns, for example, 10 nm-15 microns, for example, 10 nm-14 microns, for example, 10 nm-13 microns, for example, 10 nm-12 microns, for example, 10 nm-11 microns, for example, 10 nm-10 microns, for example, 10 nm-9 microns, for example, 10 nm-8 microns, for example, 10 nm-7 microns, for example, 10 nm-6 microns, for example, 10 nm-5 microns, for example, 10 nm-4 microns, for example, 10 nm-3 microns, for example, 10 nm-2 microns, for example, 10 nm-1 microns, for example, 10 nm-900 nm, for example, 10 nm-850 nm, for example, 10 nm-800 nm, for example, 10 nm-750 nm, for example, 10 nm-700 nm, for example, 10 nm-650 nm, for example, 10 nm-600 nm, for example, 10 nm-550 nm, for example, 10 nm-500 nm, for example, 10 nm-450 nm, for example, 10 nm-400 nm, for example, 10 nm-350 nm, for example, 10 nm-300 nm. In one embodiment the crystalline component has an average particle size in the range of 10 nm-1 micron that is dispersed substantially uniformly within the glass component. In another embodiment the crystalline component has an average particle size in the range of 10 nm-5 microns that is dispersed substantially uniformly within the glass component. In a further embodiment the crystalline component has an average particle size in the range of 10 nm-2 microns that is dispersed substantially uniformly within the glass component.

In one embodiment, a GC article without an antimicrobial agent therein or thereon is provided and subjected to an ion-exchange process using an ion-exchange bath containing at least one ion-exchangeable antimicrobial agent salt and an exchangeable alkali metal salt. In one embodiment the antimicrobial agent salt and the alkali metal salt are present in the bath as a nitrate. The alkali metal can be, for example, sodium nitrate, potassium nitrate or a mixture thereof. The concentration of the salts containing the antimicrobial agent(s) in the ion-exchange bath, in some embodiments, is in the range of 1 wt % to 100 wt %. The balance of the bath can be a salt of an alkali metal or an alkaline earth metal. In some embodiments, the concentration of the salts containing the antimicrobial agent(s) in the ion-exchange bath is in the range of 5 wt % to 100 wt %.

The concentration of the silver salt or copper salt, or mixture thereof, in the ion-exchange bath can be in the range of 0.01 wt % to 10 wt %. In one embodiment, the concentration of the silver salt or copper salt, or mixture thereof, in the ion-exchange bath is in the range of 0.01 wt % to 5 wt %.

The ion-exchange temperatures can be in the range of 300-500° C. with an ion-exchange time in the range of greater than 5 minutes to less than 6 hour. The temperature range could be higher if sulfate is present. The exact choice of time and temperature will be dependent on the depth of layer sought to be exchanged into the GC. For example, when it is desired to primarily have the antimicrobial agent(s) ion-exchanged onto the surface or near the surface of the GC, the ion-exchange is carried out at a temperature in the range of 350-420° C., depending for example on the bath used, for a time of one hour or less time; for example without limitation, at a temperature of 420° C. for a time in the range of 5 minutes to 20 minutes. If it is desired to have the antimicrobial ion-exchanged deeply into the GC, the ion-exchange can be carried out at higher temperatures for a longer time, for example without limitation, at a temperature of 450° C. for a time in the range of 4-6 hours.

In some embodiments, in the antimicrobial article the antimicrobial agent is silver and the article has a surface concentration of silver, determined as Ag₂O, of 1-20 wt %. In some embodiments, in the antimicrobial article the antimicrobial agent is copper and the article has a surface concentration of copper, determined as CuO, of 1-20 wt %. In some embodiments, in the antimicrobial article the antimicrobial agent is a mixture of copper and silver and the article has a surface concentration of copper and silver, determined as Ag₂O and CuO, of 1-20 wt % .

In some embodiments, in the antimicrobial article the antimicrobial agent is silver and the article has a surface concentration of silver, determined as Ag₂O, of 6 wt % or less. In some embodiments, in the antimicrobial article the antimicrobial agent is copper and the article has a surface concentration of copper, determined as CuO, of 6 wt % or less. In some embodiments, in the antimicrobial article the antimicrobial agent is a mixture of copper and silver and the article has a surface concentration of copper and silver, determined as Ag₂O and CuO, of 6 wt % or less.

In some embodiments, in the antimicrobial article the antimicrobial agent is silver and the article has a surface concentration of silver, determined as Ag₂O, of 1-6 wt %. In some embodiments, in the antimicrobial article the antimicrobial agent is copper and the article has a surface concentration of copper, determined as CuO, of 1-6 wt %. In some embodiments, in the antimicrobial article the antimicrobial agent is a mixture of copper and silver and the article has a surface concentration of copper and silver, determined as Ag₂O and CuO, of 1-6 wt %.

In another embodiment GC-forming components such as sand, sodium and/or potassium oxide, aluminum oxide, borate magnesia and/or other components as need to form a specific GC material were dry mixed in an appropriate vessel and a solution of the antimicrobial agent salt(s) was added to the dry materials during mixing, for example, by spraying the solution of antimicrobials agent s into the vessel. In some embodiments, the solution is an aqueous solution. After all of the antimicrobial salt containing solution has been added to the dry mixture and thoroughly mixed, the resulting batch of materials was melted and formed into a glass. Subsequently the glass was heated to a nucleation temperature for a selected time, the nucleation time, and then heated to a ceramming temperature for a selected time, the ceramming time, to form a glass-ceramic.

In both the foregoing methods, the methods can further comprising reducing the resulting antimicrobial agent(s) in the antimicrobial containing GC by heating in a reducing atmosphere at a selected temperature for a selected time to reduce the antimicrobial agent(s) to the zero valent form. The reducing conditions use a hydrogen atmosphere, for example, a pure H₂ environment, at a pressure in the range of 1-10 atmospheres at a temperature in the range of from 300° C. to 600° C., for example, 350° C. to 500° C. for a time in the range of from 1-6 hours, for example, 2-6 hours or, for example, 1-5 hours. Other reducing substance such as forming gas can also be used.

Glass-ceramics found useful for preparing antimicrobial GCs contain 20-98 Vol. % crystalline component and 2-80 Vol. % glass component. The antimicrobial glass-ceramics can be optically transparent or non-transparent and they can be colored or non-colored (that is, clear), where clear means no visible coloration. Thus, a transparent glass-ceramic can be either clear or colored. White and black are considered colors herein.

The GC materials that can be used in practicing the disclosure can be selected from the group consisting of beta-spodumene solid solution (including both Li and Cu types, and solid solutions of Li, Cu, Mg, and Na), beta-quartz solid solutions (including beta-eucryptite and virgilite), nepheline solid solutions, carnegieite solid solutions, pollucite, leucite (K[AlSi₂O₆), trisilicic fluormicas (including phlogopite and biotite), tetrasilicic fluormicas (including taeniolite and polylithionite), alkali-bearing cordierite and osumilite, GCs containing substantial alkali aluminosilicate or alkali borosilicate glass, canasite, agrellite and fluoramphiboles. Exemplary GCs used herein include beta-spodumene and beta-quartz solid solutions and Macor™ (Corning Incorporated) which is a machinable, white, odorless, porcelain-like (in appearance) GC material that has the appearance of porcelain and is 55 Vol % fluorophlogopite mica and 45 Vol % borosilicate glass. In one embodiment, the antimicrobial GC is optically transparent and has a color or is uncolored. In another embodiment, the antimicrobial GC is translucent or opaque and has a color.

According to some embodiments, the GCs may have compositions as described by the ranges in Table 1. The compositions are listed in weight percent.

TABLE 1

| | Composition | | | | |
|---|---|---|---|---|---|
| Wt % | Beta-quartz | Beta-spodumene | Nepheline | Fluormica (including Macor) | Canasite |
| SiO₂ | 40-85 | 50-80 | 40-60 | 35-65 | 54-62 |
| B₂O₃ | 0-5 | 0-5 | 0-5 | 0-5 | |
| Al₂O₃ | 10-40 | 10-30 | 20-40 | 3-25 | 1-4 |
| Li₂O | 0-12 | 2-9 | 0-2 | 0-7 | |
| MgO | 0-15 | 0-7 | 0-5 | 5-30 | 0-2 |
| ZnO | 0-20 | 0-7 | 0-7 | 0-10 | 0-2 |
| (Li₂O + MgO + ZnO) | 2-20 | 2-23 | 0-14 | 5-47 | 0-4 |
| Na₂O | 0-7 | 0-7 | 5-25 | 0-15 | 6-10 |
| K₂O | 0-7 | 0-7 | 0-20 | 0-20 | 6-12 |
| (CuO + Cu₂O) | 0-20 | 0-20 | 0-10 | 0-15 | 1-5 |
| Ag₂O | 0-20 | 0-20 | 0-10 | 0-15 | 1-5 |
| BaO | 0-10 | 0-7 | 0-10 | 0-25 | |
| TiO₂ | 0-12 | 0-1 | 0-15 | 0-7 | |
| ZrO₂ | 0-12 | 0-12 | 0-10 | 0-7 | |
| SnO₂ | 0-5 | 0-5 | 0-5 | 0-5 | |
| (TiO₂ + ZrO₂ + SnO₂) | 2-15 | 2-15 | 3-20 | 0-19 | |
| P₂O₅ | 0-10 | 0-7 | 0-7 | 0-7 | |
| CaO | 0-7 | 0-5 | 0-15 | 0-10 | 17-25 |
| SrO | | | | 0-20 | |
| F | | | | 3-12 | 4-8 |
| (K₂O + Na₂O + BaO + SrO) | 0-24 | 0-21 | 5-55 | 2-25 | 12-22 |
| Other | 0-10 | 0-10 | 0-15 | 0-10 | 0-10 |

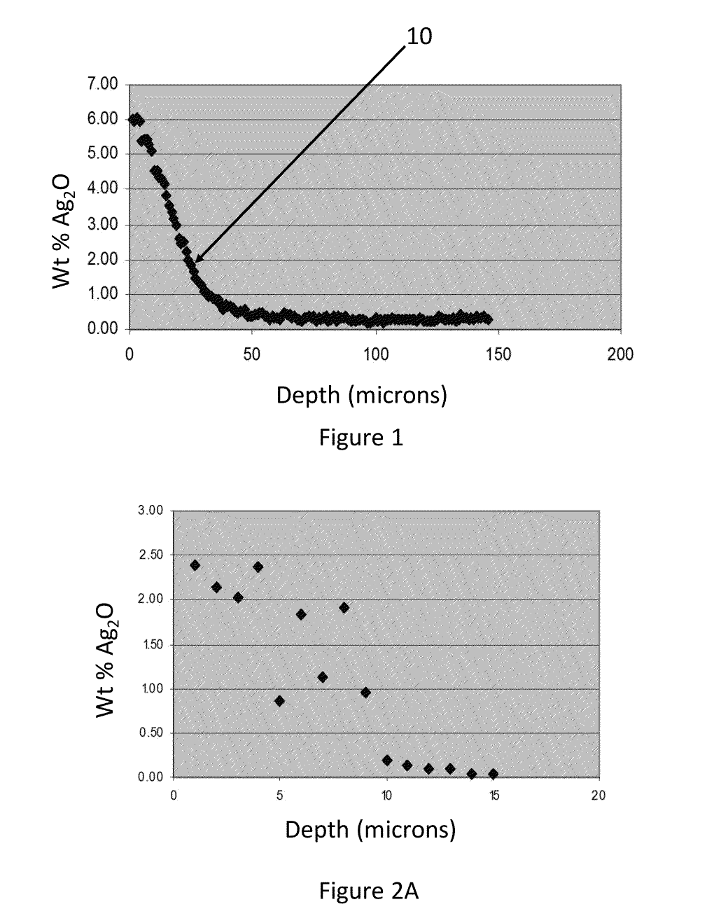

FIG. 1 is an electron microprobe (EMP) analysis of a spodumene-type glass-ceramic after ion-exchange using a 5 wt % AgNO₃/95 wt % NaNO₃ bath at 420° C. for 20 minutes. Line 10 shows the wt % of Ag₂O present in the GC as a function of depth in microns.

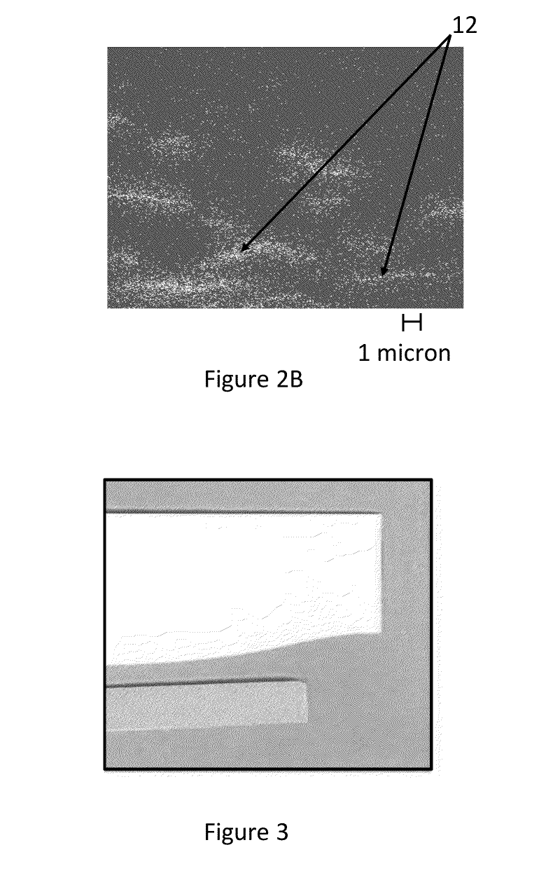

FIG. 2A is an EMP analysis after ion-exchange using a 5 wt % AgNO₃/95 wt % NaNO₃ bath at 450° C. for 5 hours. Data points show the wt % of Ag₂O present in the GC as a function of depth in microns.

FIG. 2B is an Ag map of the glass-ceramic of FIG. 2A. The light areas 12 show increased Ag concentration.

FIG. 3 is a photograph of a spodumene GC (a) after ion-exchange at 420° C. for 20 minutes using 5 wt % Ag in a NaNO₃ bath (top, GC is white) and (b) after reduction at 420° C. for 5 hours in H₂ at 1 atmosphere pressure (bottom, GC is grey).

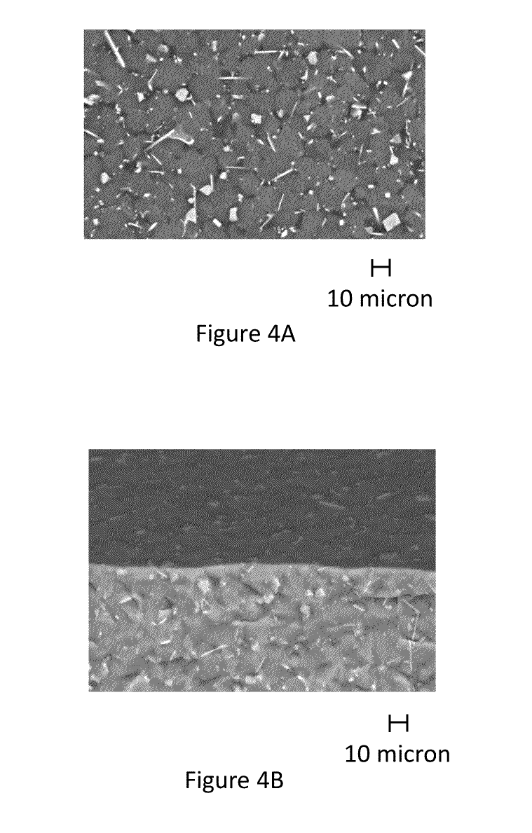

FIG. 4A and 4B are SEM micrographs of the surface (FIG. 4A) and edge (FIG. 4B) of a spodumene GC after ion-exchange using a 5 wt % AgNO₃/95 wt % NaNO₃ bath at 420° C. for 20 minutes.

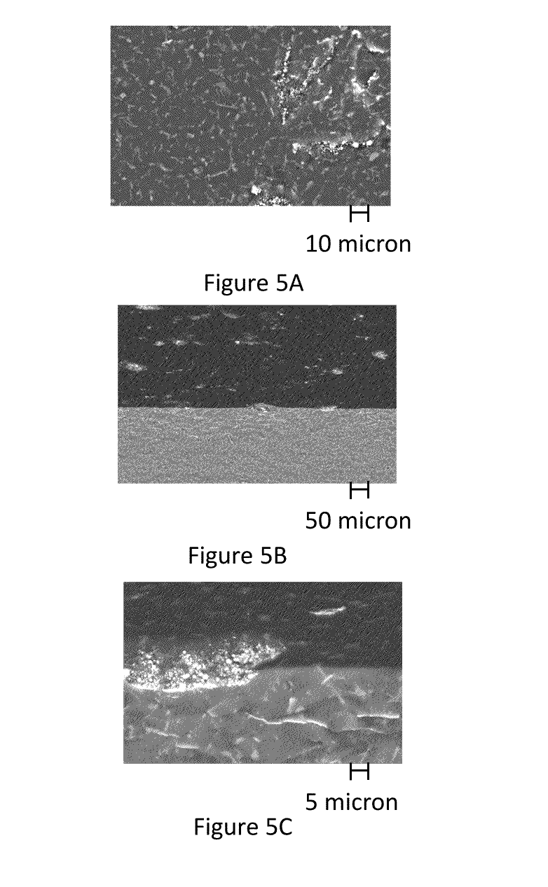

FIGS. 5A-5C are SEM micrographs of the spodumene GC of FIGS. 4A/4B after reduction at 450° C. for 5 hours in 1 atmosphere H₂.

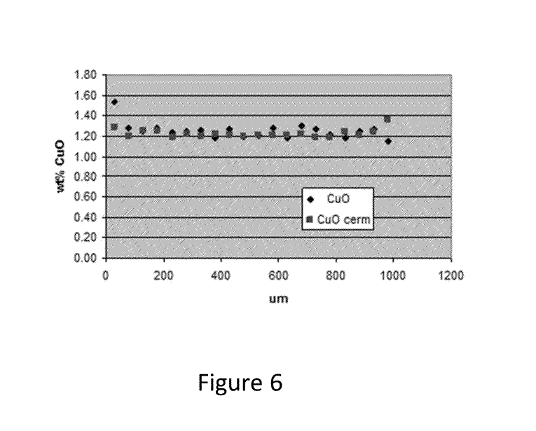

FIG. 6 is the EMP analysis of a spodumene GC containing 1 mole % CuO as- made after heat treatment at 1100 ° C.

Exemplary compositions are shown in Table 2, Compositions A and B are examples of Macor™ and nepheline compositions, respectively, and examples C, D, E, and F are examples of beta-quartz. Table 3, examples K, L, M, N, O, and P, shows examples of beta-spodumene. Example Q in Table 3 is an exemplary fluormica glass- ceramic. Example R in Table 3 is an exemplary canasite glass-ceramic. Example S in Table 3 is an exemplary spodumene glass-ceramic. Tables 2 and 3 give representative compositions of several of the glass-ceramic materials that were evaluated and tested for antimicrobial activity. According to some embodiments, the GCs listed in Tables 1, 2, and 3 can be used as a base GC and the ion-exchanged to provide or increase the amount of copper, silver, or combinations thereof in the GC. According to some embodiments, the GCs listed in Tables 1, 2, and 3 can have concentrations of silver, copper, or combinations thereof in the range of from 0-20 wt %, for example, 1-20 wt %, for example, 1-19 wt %, for example, 1-18 wt %, for example, 1-17 wt %, for example, 1-16 wt %, for example, 1-15 wt %, for example, 1-14 wt %, for example, 1-13 wt %, for example, 1-12 wt %, for example, 1-11 wt %, for example, 1-10 wt %, for example, 1-9 wt %, for example, 1-8 wt %, for example, 1-7 wt %, for example, 1-6 wt %, for example, 1-5 wt %, or, for example, 2-20 wt %, for example, 3-20 wt %, for example, 4-20 wt %, for example, 5-20 wt %, for example, 6-20 wt %, for example, 7-20 wt %, for example, 8-20 wt %, for example, 9-20 wt %, for example, 10-20 wt %, for example, 11-20 wt %, for example, 12-20 wt %, for example, 13-20 wt %, for example, 14-20 wt %, for example, 15- 20 wt %, for example.

TABLE 2

| | Examples | | | | | |
|---|---|---|---|---|---|---|
| Wt % | A | B | C | D | E | F |
| SiO₂ | 47.2 | 43.3 | 64.7 | 61.2 | 64.7 | 61.2 |
| B₂O₃ | 8.5 | 0 | 0 | 0 | 0 | 0 |
| Al₂O₃ | 16.7 | 29.8 | 18.3 | 17.3 | 18.3 | 17.3 |
| Li₂O | 0 | 0 | 2.63 | 2.49 | 2.63 | 2.49 |
| MgO | 14.5 | 0 | 1.69 | 1.60 | 1.69 | 1.60 |
| ZnO | 0 | 0 | 0.95 | 0.90 | 0.95 | 0.90 |
| (Li₂O + MgO + ZnO) | 14.5 | 0 | 5.27 | 4.99 | 5.27 | 4.99 |
| Na₂O | 0 | 14.0 | 0.02 | 0.02 | 0.02 | 0.02 |
| K₂O | 9.5 | 0 | 0 | 0 | 0 | 0 |
| (CuO + Cu₂O) | 1-5 | 0 | 5.77 | 10.91 | 5.77 | 10.91 |
| BaO | 0 | 5.5 | 0 | 0 | 0 | 0 |
| TiO₂ | 0 | 6.5 | 2.45 | 2.31 | 2.45 | 2.31 |
| ZrO₂ | 0 | 0 | 1.70 | 1.60 | 1.70 | 1.60 |
| SnO₂ | 0 | 0 | 0.55 | 0.52 | 0.55 | 0.52 |
| (TiO₂ + ZrO₂ + SnO₂) | 0 | 6.5 | 4.70 | 4.43 | 4.70 | 4.43 |
| P₂O₅ | 0 | 0 | 0 | 0 | 0 | 0 |
| CaO | 0 | 0 | 0.02 | 0.02 | 0.02 | 0.02 |
| SrO | 0 | 0 | 0 | 0 | 0 | 0 |
| F | 6.3 | 0 | 0 | 0 | 0 | 0 |
| (K₂O + Na₂O + BaO + SrO) | 9.50 | 19.5 | 0.02 | 0.02 | 0.02 | 0.02 |
| As₂O₃ | 0 | 0.9 | 0 | 0 | 0 | 0 |
| NO₂ | 0 | 0 | 0.43 | 0.41 | 0.43 | 0.41 |
| Other | 0 | 0 | 0 | 0 | 0 | 0 |

TABLE 3

| | Examples | | | | | | | | |
|---|---|---|---|---|---|---|---|---|---|
| Wt % | K | L | M | N | O | P | Q | R | S |
| SiO₂ | 65.23 | 65.48 | 65.09 | 63.25 | 65.58 | 64.81 | 42.2 | 57.54 | 65.48 |
| B₂O₃ | 1.96 | 1.97 | 1.95 | 1.90 | 1.97 | 1.95 | 11.7 | 0 | 1.97 |
| Al₂O₃ | 19.91 | 19.99 | 19.87 | 19.31 | 20.01 | 19.78 | 17 | 2.00 | 19.99 |
| Li₂O | 3.36 | 3.61 | 3.36 | 2.17 | 3.38 | 3.57 | 0 | 0 | 3.61 |
| MgO | 1.83 | 1.83 | 1.82 | 1.77 | 1.84 | 1.82 | 10.6 | 0 | 1.83 |
| MgF | 0 | 0 | 0 | 0 | 0 | 0 | 14 | 0 | 0 |
| ZnO | 2.16 | 2.17 | 2.16 | 2.1 | 2.17 | 2.15 | 0 | 0 | 2.17 |
| (Li₂O + MgO + ZnO) | 7.35 | 7.61 | 7.34 | 6.04 | 7.39 | 7.54 | 0 | 0 | 7.61 |
| Na₂O | 0.3 | 0 | 0 | 0.29 | 0 | 0.3 | 0 | 7.98 | 0 |
| K₂O | 0 | 0 | 0 | 0 | 0 | 0 | 4.4 | 8.78 | 0 |
| (CuO + Cu₂O) | 0 | 0 | 0 | 0 | 0.62 | 1.24 | 4 | 0 | 0 |
| Ag | 0.84 | 0.52 | 1.35 | 4.91 | 0 | 0 | 0 | 0 | 0 |
| BaO | 0 | 0 | 0 | 0 | 0 | 0 | 0 | 0 | 0 |
| TiO₂ | 4.37 | 4.39 | 4.36 | 4.24 | 4.39 | 4.34 | 0 | 0 | 4.39 |
| ZrO₂ | 0 | 0 | 0 | 0 | 0 | 0 | 0 | 0 | 0 |
| SnO₂ | 0 | 0 | 0 | 0 | 0 | 0 | 0 | 0 | 0 |
| (TiO₂ + ZrO₂ + SnO₂) | 4.37 | 4.39 | 4.36 | 4.24 | 4.39 | 4.34 | 0 | 0 | 4.39 |
| P₂O₅ | 0 | 0 | 0 | 0 | 0 | 0 | 0 | 0 | 0 |
| CaO | 0 | 0 | 0 | 0 | 0.62 | 0.02 | 0 | 19.71 | 0 |
| SrO | 0 | 0 | 0 | 0 | 0 | 0 | 0 | 0 | 0 |
| F | 0 | 0 | 0 | 0 | 0 | 0 | 0 | 6.11 | 0 |
| (K₂O + Na₂O + BaO + SrO) | 0.3 | 0 | 0 | 0.29 | 0 | 0.3 | 0 | 0 | 0 |
| As₂O₃ | 0 | 0 | 0 | 0 | 0 | 0 | 0 | 0 | 0 |
| Fe₂O₃ | 0.02 | 0.02 | 0.02 | 0.01 | 0.02 | 0.02 | 0 | 0 | 0.02 |
| NO₂ | 0 | 0 | 0 | 0 | 0 | 0 | 0 | 0 | 0 |
| Cl− | 0 | 0 | 0 | 0 | 0 | 0.01 | 0 | 0 | 0 |
| Other | | | | | | | | | |

Antimicrobial agent containing GCs have been tested for their antimicrobial activity, for example, using methods described below, and some of the antimicrobial GCs have a Log Reduction of >2. In some embodiments, the article has an antimicrobial Log Reduction of >0.2, for example, >0.5, for example, >1, for example, >1.5, for example, >2, for example, >2.5, for example, >3, for example, >3.5, for example, >4, for example, >4.5, for example, >5. In some embodiments, the article has an antiviral Log Reduction of >4 and an antibacterial Log Reduction >5. In some embodiments, the article is capable of inhibiting at least 2 microbial species to a Log Reduction >1 within 1 hour. In some embodiments, the article has an antibacterial Log Reduction of greater than 4 after 6 hours.

Antibacterial testing, for example, antibacterial-wet tests were performed on several exemplary glass-ceramics. Each testing sample glass-ceramic was cut into a glass-ceramic slide of 1×1 inch and put into petridish. Three uncoated glass-ceramic slides were used as negative controls. Gram negative E. coli bacteria were suspended in a 1/500 Luria broth (LB) medium at a concentration of 1×10⁶ cell/ml. 156 μl of E. coli cell suspension was placed onto each sample surface and held in close contact by using a sterilized laboratory PARAFILM, and incubated for 6 hours at 37° C. at saturation humidity (>95% relative humidity). Each sample was done in triplicate. After 6 hours of incubation, 2 ml of Phosphate Buffered Saline (PBS) buffer was added into each petridish. After shaking, both the slide and PARAFILM were washed, and all the solution from each petridish was collected and placed onto a LB agar plate. After a further 16 hr incubation at 37° C. incubator, bacteria colony formation was examined. Geometric means were used to calculate the log and percent reduction based on the colony number glass-ceramic and control glass-ceramic.

Antibacterial testing, for example, antibacterial-dry tests were performed on several exemplary glass-ceramics. Each testing sample glass-ceramic was cut into a glass-ceramic slide of 1×1 inch and put into petridish in triplicate. Non copper doped (uncoated) glass-ceramic slides were used as negative controls. Gram positive Staphylococcus aureus bacterial was cultured for at least 3 consecutive days before and on the day of testing, the inocula was culture for at least 48 hours. The bacterial culture was Vortexed, serum(5% final concentration) was added and Triton X-100 (final concentration 0.01%) was added to the inocula. Each sample was inoculated with 20 ul aliquot of the bacterial suspension, samples were allowed to dry for 3040 minutes at room temperature, and at 42% relative humidity. The samples were exposed for two hours immediately after drying. After 2 hours, 4 ml of PBS buffer was added into each petridish. After shaking, all the solution from each petridish was collected and placed onto Trypticase soy agar plates. After a further 24 hr incubation at 37° C., bacteria colony formation was examined. Geometric means were used to calculate the log and percent reduction based on the colony number glass and control glass.

An exemplary beta-quartz GC with 5 wt % Cu, example E in Table 2, had a crystal phase developed using the following thermal treatment: 720° C./2 h+850° C./4 h (this is a dual thermal treatment where the first step is a treatment at 720° C. with a hold time of 2 hours and the second step is a treatment at 850° C. for 4 hours. This nomenclature is used herein to describe dual thermal treatments) to produce beta-quartz phase. This exemplary GC was optically translucent to transparent. The treatment in H₂ and antimicrobial activity is listed in Table 4.

TABLE 4

| H₂ | Test | Log kill |
|---|---|---|
| 300 C./5 h | Dry | 1.5 |
| 350 C./5 h | Dry | 2.3 |
| 400 C./5 h | Dry | 3.1 |
| None | Dry | 0.2 |
| 450 C./5 h | Dry | 1.6 |

An exemplary spodumene GC with Cu, example E in Table 2, had a crystal phase developed using the following thermal treatment: 720° C./2 h+1000° C./4 h to produce spodumene phase. The treatment in H₂ and antimicrobial activity is listed in Table 5.

TABLE 5

| H₂ | Test | Log kill |
|---|---|---|
| 450 C./5 h | Wet | 5 |
| 450 C./5 h | Dry | 1.6 |

An exemplary spodumene GC with 5 wt percent Ag, example N in Table 3, had a crystal phase developed using the following thermal treatment: 720° C./2 h+1000° C./4 h to produce spodumene phase. The treatment in H₂ and antimicrobial activity is listed in Table 6.

TABLE 6

| | | Log |
|---|---|---|
| H₂ | Test | kill |
| None | Wet | 4 |

An exemplary spodumene ion-exchanged GC with Ag (Ag was added by 5% AgNO₃ in a bath concentration ion-exchange), example S is the base GC prior to ion- exchange in Table 3, had a crystal phase developed using the following thermal treatment: 720° C./2 h+1000° C./4 h to produce spodumene phase. The measured wt % of Ag₂O was 16 wt %. The treatment in H₂ and antimicrobial activity is listed in Table 7.

TABLE 7

| | | Log |
|---|---|---|
| H₂ | Test | kill |
| None | Wet | 5 |

An exemplary spodumene ion-exchanged GC with Ag, example S is the base GC prior to ion-exchange in Table 3, had a crystal phase developed using the following thermal treatment: 720° C./2 h+1000° C./4 h to produce spodumene phase. Ag was added by AgNO₃ ion-exchange at 350° C./10 min as shown in Table 8. The GC was also Na ion- exchanged at 390° C./3.5 h to strengthen the GC. The treatment in H₂ and antimicrobial activity is listed in Table 8.

TABLE 8

| H₂ | Test | Log Kill | % AgNO₃ |
|---|---|---|---|
| None | Dry | 1.03 | 5 |
| None | Dry | 2.7 | 50 |
| None | Dry | 2.3 | 100 |

An exemplary mica GC with Cu, example A in Table 2, had a crystal phase developed using the following thermal treatment: 720° C./2 h+950° C./4 h to produce mica phase. The treatment in H₂ and antimicrobial activity is listed in Table 9.

TABLE 9

| H₂ | Test | Log Kill |
|---|---|---|
| 350 C./5 h | Dry | 1.32 |
| 450 C./5 h | Dry | 2.3 |
| 400 C./5 h | Dry | 1.6 |

An exemplary canasite GC with Cu, example R is the base GC prior to ion-exchange in Table 3, had a crystal phase developed using the following thermal treatment: 720° C./2 h+850° C./4 h to produce canasite phase. The first exemplary canasite in Table 10 was ion-exchanged with Ag at 450° C./20 min with 5% AgNO₃. The treatment in H₂ and antimicrobial activity is listed in Table 10.

TABLE 10

| | | Log |
|---|---|---|
| H₂ | Test | Kill |
| None | Wet | 2.3 |
| 450 C./5 h | Wet | 1.5 |

An exemplary Macor™ GC with Cu, example A in Table 2, had a crystal phase developed using the following thermal treatment: 720° C./2 h+950° C./4 h to produce Macor™ phase. The first exemplary Macor™ in Table 11 was ion-exchanged with Ag at 450° C./20 min with 5% AgNO₃. The treatment in H₂ and antimicrobial activity is listed in Table 11.

TABLE 11

| | | Log |
|---|---|---|
| H₂ | Test | Kill |
| None | Wet | 1.57 |
| 450 C./5 h | Wet | 1.2 |

An exemplary nepheline GC with 5 wt % Cu, example B in Table 2, had a crystal phase developed using the following thermal treatment: 850° C./4 h+1100° C./6 h to produce nepheline phase. The treatment in H₂ and antimicrobial activity is listed in Table 12.

TABLE 12

| | | Log |
|---|---|---|
| H₂ | Test | Kill |
| 450 C./5 h | Dry | 0.7 |

The data indicates that at a Cu doping level of 1 wt % Cu the cerammed GC without H₂ reduction had an antibacterial LR >2 (>99% bacteria reduction) and with H₂ reduction had an LR >5 (>99.999 bacterial reduction). A beta-quartz containing GC prepared using Cu added to the batch materials before melting, forming and ceramming was found to have an as-made, no H₂ reduction, antimicrobial activity of >2, the Cu-GC being both antibacterial and antiviral. In one embodiment wherein the batch materials were doped to contain 5 wt % Cu prior to melting, forming and ceramming, the as-made, no H₂ reduction antimicrobial activity as >5.

While some embodiments have been set forth for the purpose of illustration, the foregoing description should not be deemed to be a limitation on the scope of the disclosure or the appended claims. Accordingly, various modifications, adaptations, and alternatives may occur to one skilled in the art without departing from the spirit and scope of this disclosure or the appended claims.

What is claimed is:

1. An antimicrobial article comprising:
a substrate comprising a glass-ceramic having a crystalline component and an amorphous component; and
a reduced copper antimicrobial agent, and
wherein the glass-ceramic substrate comprises a glass-ceramic selected from the group consisting of beta-spodumene solid solution, beta-quartz solid solutions, nepheline solid solutions, carnegieite solid solutions, pollucite, leucite (K[AlSi₂O₆]), trisilicic fluormicas, tetrasilicic fluormicas, alkali-bearing cordierite and osumilite, glass-ceramics containing substantial alkali aluminosilicate or alkali borosilicate glass, canasite, agrellite and fluoramphiboles.

2. The antimicrobial article of claim 1, wherein the reduced copper antimicrobial agent comprises a zero valent form.

3. The antimicrobial article according to claim 1, wherein the article has an antiviral Log Reduction of greater than about 4 and an antibacterial Log Reduction of greater than about 5.

4. The antimicrobial article according to claim 1, wherein the article is capable of inhibiting at least 2 microbial species to a Log Reduction of greater than about 1 within 1 hour.

5. The antimicrobial article according to claim 1, wherein the article has an antibacterial Log Reduction of greater than 4 after 6 hours.

6. The antimicrobial article according to claim 1, wherein the antimicrobial article comprises a surface concentration of the reduced copper antimicrobial agent, determined as CuO, in the range from about 1 wt % to about 20 wt % .

7. The antimicrobial article according to claim 1, wherein the glass-ceramic is selected from the group consisting of beta-spodumene solid solution, beta-quartz solid solutions, nepheline solid solutions, carnegieite solid solutions, pollucite, leucite (K[AlSi₂O₆), trisilicic fluormicas, tetrasilicic fluormicas, alkali-bearing cordierite and osumilite, glass-ceramics containing substantial alkali aluminosilicate or alkali borosilicate glass, canasite, agrellite and fluoramphiboles.

8. The antimicrobial article according to claim 1, wherein the crystalline component comprises particles having a particle size in the range from about 10 nm to about 750 nm, and wherein the particles are dispersed substantially uniformly within the amorphous glass component.

9. A method of making a antimicrobial article comprising the steps of:
providing a glass-ceramic substrate having a crystalline component and an amorphous component; and
subjecting said glass-ceramic substrate to an ion-exchange process using an ion-exchange bath containing at least one ion-exchangeable antimicrobial agent salt comprising copper to thereby form an antimicrobial glass-ceramic article comprising copper.

10. The method of claim 9, wherein the ion exchange bath comprises an alkali metal salt.

11. The method of claim 9, wherein the glass-ceramic substrate comprises a glass-ceramic selected from the group consisting of beta-spodumene solid solution, beta- quartz solid solutions, nepheline solid solutions, camegieite solid solutions, pollucite, leucite (K[AlSi₂O₆), trisilicic fluormicas, tetrasilicic fluormicas, alkali-bearing cordierite and osumilite, glass-ceramics containing substantial alkali aluminosilicate or alkali borosilicate glass, canasite, agrellite and fluoramphiboles.

12. The method of claim 9, wherein the antimicrobial glass-ceramic article comprises a surface concentration of copper, determined as CuO, in the range from about 1 wt % to about 20 wt % .

13. The method of claim 9, further comprising reducing the copper in the antimicrobial glass-ceramic article in a hydrogen atmosphere.

14. The method of claim 13, wherein the hydrogen atmosphere comprises a pressure in the range from about 1 atmosphere to about 10 atmospheres and a temperature in the range from about 350° C. to about 500° C.

15. The method of claim 13, wherein the antimicrobial article is reduced in the hydrogen atmosphere for a time in the range from about 1 hour to about 5 hours.

16. A method of forming an antimicrobial article comprising:
combining glass-ceramic forming components comprising any one more of sand, sodium oxide, potassium oxide, aluminum oxide, and borate magnesia;
adding a solution of an antimicrobial agent salt to the glass-ceramic forming components to form; and
melting and forming the combined glass-ceramic forming components and solution of antimicrobial agent salt into a glass.

17. The method of claim 16, further comprising heating the glass to form a glass- ceramic.

18. The method of claim 16, wherein adding the solution of the antimicrobial agent salt comprises spraying the solution of antimicrobials agents.

19. The method of claim 17, further comprising heating the glass-ceramic in a reducing atmosphere.

20. The method of claim 19, wherein the reduction atmosphere comprises a hydrogen and a pressure in the range from about 1 atmosphere to about 10 atmospheres at a temperature in the range from about 300° C. to 600° C.
